(19) United States
(12) Patent Application Publication
(10) Pub. No.: US 2007/0210064 A1
(43) Pub. Date: Sep. 13, 2007

(54) SYSTEM FOR WARMING FOOD

(75) Inventors: John Quella, Sturgeon Bay, WI (US); Allan Witt, Lenoir, NC (US); William Citti, Brookfield, WI (US); David Rolston, Milwaukee, WI (US)

Correspondence Address: FOLEY & LARDNER LLP, 777 EAST WISCONSIN AVENUE, MILWAUKEE, WI, 53202-5306, US

(73) Assignee: Hatco Corporation

(21) Appl. No.: 11/276,587

(22) Filed: Mar. 6, 2006

(51) Int. Cl. H05B 3/68

(52) U.S. Cl. 219/451.1

(57) ABSTRACT

A system for heating food includes a heated surface which may comprise a mineral an organic resin and any of a number of suitable inorganic or organic fillers.

### BACKGROUND

The present description relates to systems and methods for warming food. In particular, the present description relates to systems and methods for warming foods using a battery, fuel cell, solar, and/or other portable electric power producing device as a power source.

Over the years, a number of advances have been made in how food is cooked and served. In many situations, food is initially cooked at high temperatures and then served to those that will eat the food. The food may be served using a buffet to allow people a greater amount of choice in what they eat as well as how much they eat. One example of such a situation is a buffet style restaurant. Patrons of a buffet style restaurant move between various buffet tables and choose the food that appeals to them. Unfortunately, when food is served, it may become cold before it is completely consumed. This is particularly a problem in a buffet style setting. In general, cold food is less appealing to people than hot food, and food that is not heated properly poses a greater risk of microbial contamination, which may cause sickness or other health problems. Once the food is cold, it is typically either reheated or discarded resulting in a significant amount of waste both in terms of food and efficiency.

In an effort to counter this problem, various devices have been developed to maintain the food at a certain temperature. In one of these devices, the food is warmed using an open flame positioned directly underneath a serving dish. The flame heats the bottom of the serving dish and thus heats the food inside it. These devices use flammable materials such as propane or alcohol based fluid or gels to create the flame. In another device, the food is warmed using an electrical heating element which is plugged into an electrical outlet.

While these devices are generally effective there are some drawbacks. For example, the use of an open flame presents the risk of burning someone or starting a fire. Also, combustion of the various fuels may give off harmful gases. Using electric power from an outlet may not provide a workable solution where power is not readily available (e.g., a picnic, cookout, etc.). Also, electric power from an outlet may require placing electrical cords across walkways or other places where there is foot traffic. The exposed cords pose a tripping hazard to those walking nearby. Accordingly, it would be desirable to provide an improved system and method for warming food.

It should be understood that the claims define the scope of the subject matter for which protection is sought, regardless of whether any of the aforementioned disadvantages are overcome by the subject matter covered by the claims.

### SUMMARY

One embodiment relates to a system comprising at least one serving dish configured to support food and a power source which comprises at least one portable electrical power generating device. The power source provides power to heat the food.

Another embodiment relates to a system comprising a counter, at least one heating element in thermal communication with the counter, and a power source which comprises a portable electrical power generating device and which is configured to provide power to the heating element.

Another embodiment relates to a system comprising at least one container supporting food, at least one heating element indirectly heating the food, and at least one fuel cell configured to provide direct current power to the heating element.

Another embodiment relates to a system comprising at least one container supporting food and at least one battery configured to provide power to heat the food in the container to at least approximately 185° F.

Another embodiment relates to a chafing dish which supports food and/or uses at least one of a battery and a fuel cell to heat the food.

Another embodiment relates to a chafing dish supporting food and using direct current power to heat the food.

Another embodiment relates to a serving cart comprising a surface, at least one heating element which heats the surface, and a power source which comprises at least one of a battery and/or a fuel cell. The power source is configured to provide power to the heating element.

Another embodiment relates to a method of serving food comprising positioning a plurality of serving dishes adjacent to one another on a counter and heating food in the plurality of serving dishes using at least one of a battery and/or a fuel cell. The serving dishes comprise various types of food.

Another embodiment relates to a system comprising a counter which comprises quartz, at least one heating element in thermal communication with the counter, and a power source which provides power to the heating element.

### DRAWINGS

FIG. 1 is a perspective view of a serving cart which is configured to heat food using a battery and/or a fuel cell according to one embodiment.

FIG. 2 is top view of the serving cart of FIG. 1.

FIG. 3 is a cross-sectional side view of the serving cart of FIG. 1.

FIG. 4 is a bottom view of the serving cart of FIG. 1.

FIG. 5 is a perspective view of a serving station which is configured to heat food using a battery and/or a fuel cell according to another embodiment.

FIG. 6 is a perspective view of a chafing dish which is configured to heat food using a battery and/or a fuel cell according to another embodiment.

### DETAILED DESCRIPTION

The present description is provided in the context of systems and methods of heating food using a battery and/or a fuel cell. In particular, the use of at least one battery and/or at least one fuel cell is described in connection with heating food in a buffet setting (e.g., food displayed on a buffet table, etc.). However, the systems and methods described herein may be widely applicable beyond the particular details and embodiments described herein. Accordingly, the following description should be considered representative of the many uses and configurations of the systems and methods described herein. Also, it should be understood that the various features from one embodiment or example may be combined with one or more features from one or more other embodiments or examples to create additional embodiments unless expressly stated otherwise.

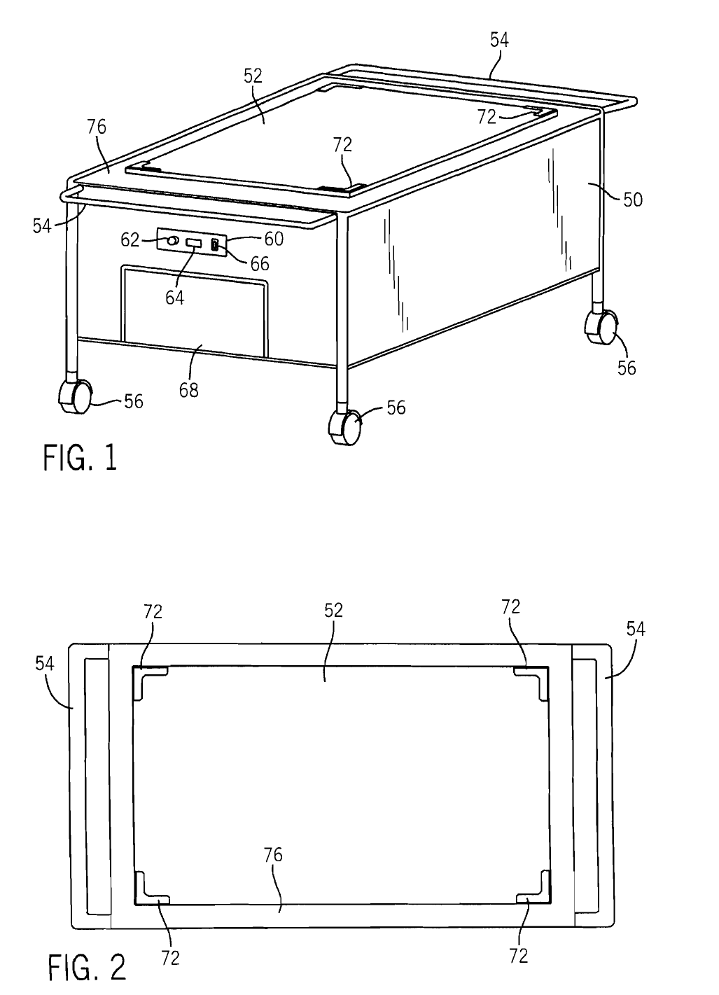

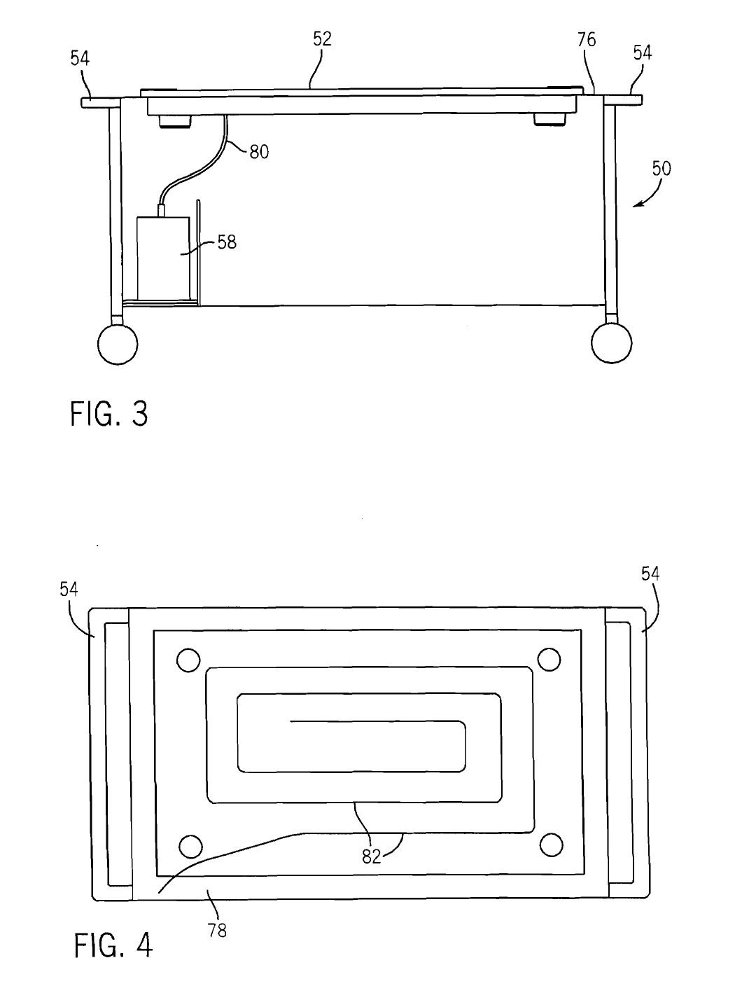

Referring to FIG. 1, a system is shown for heating food according to one embodiment. In particular, the system comprises a serving cart 50 which is portable. FIG. 1 provides a perspective view of serving cart 50. Serving cart 50 comprises a top surface, counter, or shelf 52, handles 54, and wheels 56. Serving cart 50 also includes a power source 58 (FIG. 3), which is configured to provide power to heat surface 52. Access door 68 provides access to power source 58.

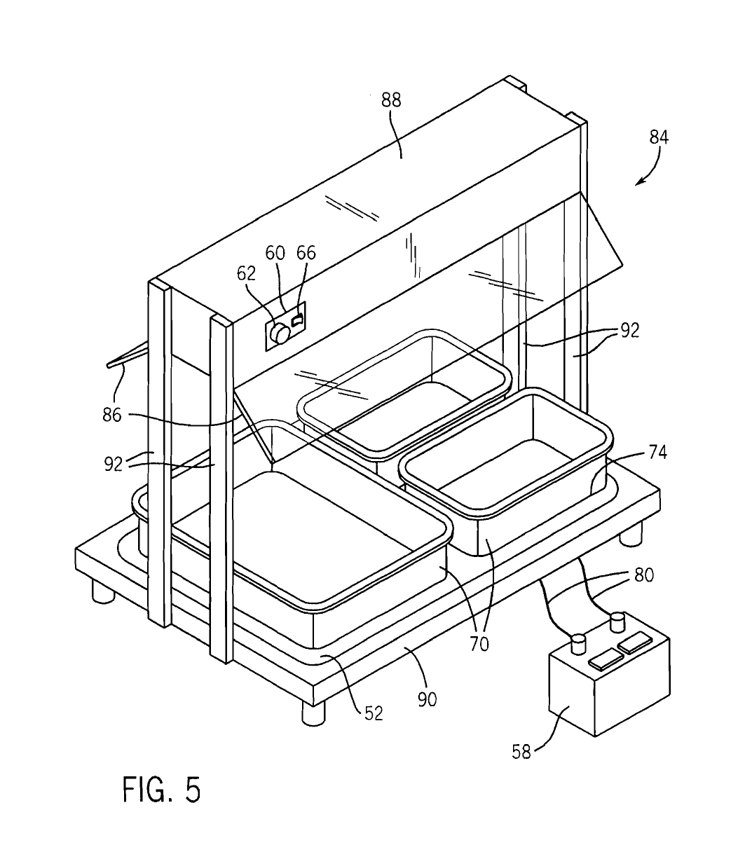

Surface 52 is used to hold one or more containers 70 (FIG. 5) of food. As an initial note, containers 70 may include a variety of dishes (e.g., serving dish, pizza pan, etc.) and may be used in conjunction with a variety of systems for heating food (e.g., chafing dish, bain-marie, table dish warmer, etc.). In a typical situation, surface 52 is configured to hold a plurality of containers 70 comprising a variety of different foods adjacent to one another. Users may choose from the food provided in containers 70 as the user moves alongside serving cart 50. In another embodiment, multiple serving carts 50 may be placed adjacent to one another to provide additional capacity to serve even more food. Surface 52 is heated to a sufficient temperature to maintain the food in containers 70 at a desired temperature. In one embodiment, the temperature of surface 52 is at least approximately 140° F., at least approximately 160° F., or, desirably, at least approximately 180° F., or, suitably, at least approximately 200° F., or, even more suitably, at least approximately 240° F. The food in containers 70 may be heated to at least approximately 140° F., at least approximately 185° F., or at least approximately 200° F. Also, it should be understood that heat or heating is meant to include maintaining food at a temperature higher than the ambient temperature (e.g., the food is already heated by cooking and only needs to be maintained at an elevated temperature). In another embodiment, food may be placed directly on surface 52. The food may be heated or maintained at the appropriate level by heating surface 52.

Surface 52 may comprise a variety of suitable materials. In general, surface 52 comprises a material that is capable of being heated without substantial adverse effects such as cracking, warping, etc (e.g., glass, etc.). The higher surface 52 is heated the more durable the material should be to withstand the higher temperatures. It should be appreciated that surface 52 may be any suitable decorative surface material that can be heated without substantial degradation. In one embodiment, surface 52 includes quartz.

In one embodiment, surface 52 may comprise an organic resin in combination with any of a number of other suitable inorganic fillers to form a composite surface. Typically, fillers are inorganic materials such as minerals, glass, fibrous materials, etc, that are included in order to provide strength, visual appeal, etc. The organic resin may be provided to act as an adhesive and hold the filler materials together. For example, surface 52 may comprise an organic resin and a mineral such as quartz. In another embodiment, surface 52 may comprise an organic resin and a mineral other than quartz. Surface 52 may also comprise an organic resin and a mineral other than quartz and/or minerals found in stone. Surface 52 may also comprise an organic resin and a natural mineral (e.g., quartz or a mineral other than quartz). Surface 52 may comprise an organic resin, one or more minerals, and/or fibrous material.

Surface 52 may include any of a number of a organic resins in widely varying amounts. For example, suitable organic resins include acrylic based resins, polyester based resins (e.g., unsaturated polyester resins, etc.), phenolic based resins, epoxy based resins, polyvinyl based resins, and so forth. For example, surface 52 may include linear polyester resins obtained from hydrogenated bis-phenol A. Surface 52 may also include resins formed using free radical polymerization of a free radical reactive material (e.g., styrene based materials polymerized to form a polystyrene resin, etc.). Surface 52 may include at least about 2 wt. % organic resin, at least about 7 wt. % organic resin, or, at least about 10 wt. % organic resin. Surface 52 may also include about 2 wt. % to 50 wt. % organic resin, about 15 wt. % to 45 wt. % organic resin, or, suitably, about 20 wt. % to 40 wt. % organic resin.

Any of a number of suitable minerals may be included in surface 52. As used herein, the term “mineral” refers to inorganic substances that are solid and have a crystal structure. Minerals may include naturally occurring and/or man-made substances that meet this criteria. In one embodiment, the minerals used in surface 52 are naturally occurring minerals. Suitable minerals that may be used in surface 52 include silicate class minerals such as feldspars, quartz, olivines, pyroxenes, amphiboles, garnets, and micas; carbonate class minerals such as calcite and aragonite (both calcium carbonate), dolomite (magnesium/calcium carbonate), siderite (iron carbonate), and nitrate and borate minerals; sulfate class minerals such as anhydrite (calcium sulfate), celestite (strontium sulfate), barite (barium sulfate), gypsum (hydrated calcium sulfate), and chromate, molybdate, selenate, sulfite, tellurate, and tungstate minerals; halide class minerals such as fluorite (calcium fluoride), halite (sodium chloride), sylvite (potassium chloride), and sal ammoniac (ammonium chloride); oxide class minerals such as hematite (iron oxide), magnetite (iron oxide), chromite (chromium oxide), spinel (magnesium aluminium oxide), rutile (titanium dioxide); sulfide class minerals such as pyrite (iron sulfide—commonly known as fools' gold), chalcopyrite (copper iron sulfide) and galena (lead sulfide); phosphate class minerals such as arsenate, vanadate, and antimonate minerals; and elemental class minerals such as gold, silver, copper, and alloys thereof. Minerals such as aluminum hydrate and aluminum trihydrate may also be included in surface 52.

In some embodiments, surface 52 may include at least about 25 wt. % minerals, at least about 45 wt. % minerals, at least about 55 wt. % minerals, or at least about 65 wt. % minerals. In other high mineral content embodiments, surface 52 may include at least about 80 wt. % minerals, at least about 85 wt. % minerals, or at least about 90 wt. % minerals. Surface 52 may also include about 25 wt. % to 75 wt. % minerals or about 30 wt. % to 70 wt. % minerals.

Surface 52 may also include a fibrous material such as glass fiber and the like. For example, surface 52 may comprise an organic resin and a fibrous material. The fibrous material may be used to provide additional strength and/or other desired properties to surface 52 such as fire resistance (the other fillers such as the minerals may also provide fire resistance). In one embodiment, surface 52 may include at least about 3 wt % of fibrous material, at least about 5 wt % of fibrous material, or, suitably, at least about 7 wt % of fibrous material. In another embodiment, surface 52 may include about 3 to 25 wt % of fibrous material, about 5 to 20 wt % of fibrous material, or, suitably, about 7 to 15 wt % of fibrous material. It should be appreciated that many of the materials that are provided in fiber form may also be provided as a powder or as spheres. For example, surface 52 may include powdered glass in addition to or in place of the fibrous material.

Surface 52 may be formed by compression molding the combination of the organic resin and any other materials such as minerals, fibrous materials, and so forth. In order to facilitate compression molding of surface 52, a low profile additive may be included. For example, suitable low profile additives include polystyrene, styrene-acrylic copolymer, methacrylate resin, polyvinyl acetate (e.g., acrylic modified polyvinyl acetate), capped PPO diluted in styrene monomer, and so forth. In one embodiment, surface 52 may include about 1 wt. % to 25 wt. % low profile additive, about 2 wt. % to 18 wt. % low profile additive, or suitably, about 3 wt. % to 15 wt. % low profile additive. Forming surface 52 (e.g., organic resin in combination with other materials, etc.) using a compression molding process may result in surface 52 being non-porous.

In one embodiment, surface 52 may include a material sold under the trade name Swanstone by the Swan Corporation, St. Louis, Mo. Swanstone is a compression molded homogeneous, non-porous material with color throughout. Swanstone is a reinforced, modified acrylic filled with natural minerals. U.S. Pat. No. 5,393,808, which is incorporated herein in its entirety, describes another material that may be used as surface 52.

In another embodiment, surface 52 may comprise stone which may include natural stone (e.g., granite, marble, etc.) and/or engineered stone. Stone provides an aesthetically pleasing look as well as being durable. The term “engineered stone” as used herein means materials comprising at least approximately 80 wt. % quartz and at least approximately 2 wt. % organic resin (e.g., acrylic based resins, phenolic based resins, polyester based resin, epoxy based resins, polyvinyl based resins, etc.). In one embodiment, engineered stone comprises approximately 90-93 wt. % of quartz and approximately 7-10 wt. % polyester based resin (e.g., engineered stone available from Dupont under the tradename “Zodiaq,” or similarly engineered stone available from Cosentino USA, Inc. of Stafford, Tex. under the tradename “Silestone,” etc.). As shown in FIGS. 1 and 2, surface 52 may comprise corner protectors 72 to prevent surface 52 from being chipped or cracked by, for example, colliding with one of containers 70. This may be particularly useful when surface 52 is stone or engineered stone. In another embodiment, surface 52 may comprise quartz. For example, surface 52 may be stone or engineered stone that includes quartz.

Surface 52 may also comprise concrete such as honed or polished concrete. Typically, polished concrete refers to concrete that has been ground using a sequence of disks ending with at least 1500 grit diamonds. Honed concrete generally refers to concrete that has been ground using a sequence of disks ending with at least 400 grit diamonds but not more than 1500 grit diamonds. The concrete may include a wide variety of materials (i.e., aesthetic fillers—materials that are only there for the purpose of increasing the aesthetical appeal of the concrete) that give the concrete a unique and aesthetically pleasing appearance once it is polished. For example, colored aggregate can be included in the concrete mix or “seeded” into the top layer of the mix. The polishing process reveals the aggregate. Integrally colored concrete can be used to form concrete surfaces having a variety of colors. Glass can be also “seeded” into the mix. The polishing process reveals the glass pieces. Numerous other objects such as nails, bolts, computer chips, and so forth can be seeded into the mix and then polished smooth. Of course, any of these options can be combined together or into a pattern.

Referring to FIG. 2, surface 52 is shown from a top view. As shown in FIGS. 1 and 2, surface 52 is substantially flat, which makes it simple to clean and maintain. However, in other embodiments surface 52 may be any suitable geometry. For example, surface 52 may comprise recesses which are slightly larger in shape than a bottom side 74 of container 70 (FIG. 5). Container 70 fits within the recesses to provide greater stability to container 70 as users remove food.

Referring to FIG. 3, a cross-sectional side view of serving cart 50 is shown. As shown in FIGS. 1 and 3, surface 52 is separate and raised above the unheated top surface 76 of serving cart 50. Typically, unheated top surface 76 is made of an electrically conducting material (e.g., stainless steel, etc.). Surface 52 may be thermally and/or electrically insulated from unheated surface 76. Therefore, at the interface between surface 52 and unheated surface 76 a suitable insulating material may be provided to prevent heat transfer between the two surfaces.

Power source 58 is configured to provide electrical energy to heat surface 52. In one embodiment, power source 58 is configured to provide direct current power (e.g., 12 Volt or any suitable voltage such as up to 36 Volts) to heat surface 52. As shown in FIG. 3, power source 58 comprises at least one battery. The battery may be any suitable battery to provide the desired power output, which, of course, will depend on a variety of factors such as the size of surface 52 and the ambient environment conditions. In one embodiment, the battery may be a 150 amp-hour battery which provides enough power to heat three square feet of surface 52 for approximately 5 hours at 240° F. In another embodiment, the battery may be at least approximately a 100 amp-hour battery, 150 amp-hour battery, 200 amp-hour battery, or 250 amp-hour battery. In general, a battery with more amp-hours can heat surface 52 longer. In another embodiment, the battery may be a deep cycle battery. In still other embodiments, power source 58 may comprise a fuel cell (e.g., hydrogen fuel cell such as a proton exchange membrane fuel cell, alkaline fuel cell, phosphoric acid fuel cell, etc.) or photovoltaic cells (e.g., photovoltaic cells may be used to directly heat surface 52, they may be used to recharge the battery, etc.). In those embodiments comprising a photovoltaic cell, the photovoltaic cell may be mounted to serving cart 50 (e.g., mounted above the cart in position to receive radiation from the sun, etc.). In yet another embodiment, the power source may include electrical generation devices which are movable and therefore portable.

It should be appreciated that although the power source 58 is shown as being a battery, the power source may also be an alternating current power source (e.g., 110 Volt wall outlet). For example, an inverter or other suitable electronics may be used to convert alternating current (e.g., 60 Hz, 75 Hz, and so forth) to direct current, which can then be used to heat surface 52. The use of alternating current may increase the efficiency of the battery, particularly when the power conserving techniques described herein are used. The use of higher voltage alternating current (e.g., up to 120 Volt) may also result in efficiency gains.

Referring to FIG. 4, a bottom side 78 of surface 52 is shown. As shown in FIGS. 3 and 4, wires 80 extend from power source 58 to bottom side 78 of surface 52. Wires 80 transmit power to one or more heating elements 82, which are attached to surface 52 and provide heat to surface 52. Heating element 82 typically comprises one or more wires with sufficiently high resistance to cause the temperature of the wire to increase as electricity is passed through it. Typically, heating element 82 is enclosed by a material such as aluminum foil. In other embodiments, heating element 82 may be configured to be inside surface 52 (e.g., manufactured inside surface 52, etc.). For example, heating element 82 may be enclosed by surface 52 which comprises at least approximately 80 wt. % quartz and at least approximately 2 wt. % organic resin. The heating element 82 may also be encased by concrete that forms surface 52. In yet another embodiment, the heating element may be provided as a coating of a resistive material applied to the bottom side 78 of the surface 52, or to an interior layer of the surface 52 (e.g., surface 52 may be made of multiple layers of materials coupled together where one of the layers includes the resistive coating). Any suitable material may be used as the resistive coating such as, for example, tin oxide. In yet another embodiment, a layer of material that is thermally conductive may be positioned between heating elements 82 and surface 52. As the heating elements 82 heat up, the heat is readily conducted through the thermally conductive material to provide more even heating of surface 52. The thermally conductive layer may be positioned on the bottom side 78 of the surface 52 so that the heating elements 82 are positioned underneath the thermally conductive layer. In those embodiments, where heating elements 82 are positioned inside surface 52, the thermally conductive layer may also be positioned inside surface 52 directly above heating elements 82.

An electronic control system, which may include a microprocessor, may be used to control heating of the surface 52. A control panel 60 provides a user interface with the electronic control system. Control panel 60 comprises a knob 62, display 64, and on/off switch 66. Knob 62 is used to adjust the temperature of surface 52. Display 64 may be used to indicate the temperature of surface 52. Control panel 60 may comprise membrane buttons to input the temperature settings, etc. The electronic control system may be used to control the temperature of surface 52 using a feedback control loop. For example, a thermostat may be used to control the temperature of the surface 52 at a set temperature. In those situations where the surface 52 is included as part of the serving cart 50 or other suitable portable unit, the control panel 60 may be positioned on the serving cart 50. In other embodiments, where the surface 52 is built-in, the control panel 60 may be positioned remotely from the surface 52 or immediately adjacent to the surface 52. The system may include and electronic control system

The electronic control system may also be used to implement a variety of power conserving techniques. For example, in those situations where the power source 58 is a battery, the electronic control system may be used to control charging and discharging of the battery. For example, the serving cart 50 may be capable of being plugged into an AC wall outlet or drawing power from the battery. When the serving cart 50 is plugged into the AC outlet, the electronic control system may be configured to automatically charge the battery. Also, power from the AC outlet may be used to preheat heating elements 82 while the electronic control system maintains the proper charge of the batteries. The electronic control system may also be configured to automatically switch the power source to the battery when AC power is no longer available (e.g., the user unplugs the unit from the AC wall outlet). The electronic control system may also be used to synchronize the on and off cycles of the various heating elements 82 in order to extend battery life (e.g., turning a first heating element on while a second is off and then turning the second one on while the first one is off). Cycling the heating elements 82 on and off according to a pattern serves to prevent all of the heating elements 82 from being on at the same time and, thus, rapidly draining the batteries.

The electronic control system may also be capable of providing low battery voltage protection and an alarm that alerts the user of the low battery condition. The alarm may be visible, audible, or both. For example, the alarm may simply be a blinking light or a beeping sound. The electronic control system may also include a battery monitor that can notify the user when the battery has gone bad.

In another embodiment the system may include a radio-frequency (RF) reader device which is used to receive information transmitted from RF tags included with the food being heated. The RF reader device may communicatively coupled to the electronic control system. In one embodiment, the RF reader device may be configured to receive information about the type of food being heated, information related to how the food should be heated (e.g., set point temperature at which the food should be maintained, or the temperature at which the RF tag or surface 52 should be maintained), etc.

In operation, the RF reader device is positioned so that when food is placed on surface 52 the RF reader device is close enough to the RF tag to transmit a signal to the RF tag. The signal wakes-up the RF tag and provides the energy that allows the RF tag to transmit the information to the reader device. Typically, the RF tag stores the information in read-only memory. However, it should be appreciated that the RF tag may store the information in programmable memory as well. The reader device may be capable of sending information to the RF tag that can be stored in the programmable memory. Suitable RF tags may be obtained from Redprairie Corp., Waukesha, Wis. 53186 or Appleton Papers, Inc., 825 E. Wisconsin Ave., Appleton, Wis. 54912.

In one embodiment, the RF tag may include a temperature sensor such as a thermal switch. The thermal switch may be configured to prevent communication from the RF tag to the reader device once the RF tag reaches a preset temperature. In this manner, the RF tag may be used to provide feedback to the electronic control system in order to prevent the food from becoming too cold or too hot. It should also be appreciated that surface 52 may be divided into multiple zones that are controlled independently of each other so that food in each zone can be heated to different temperatures. It should also be appreciated that the location of the food on the surface 62 may be determined using multiple reader devices that are capable of receiving the unique signal from each RF tag and triangulating the location of the food from the signal.

By now it should be apparent that there are many different embodiments and configurations for heating food with a battery and/or a fuel cell. Additional embodiments may include additional features that may be provided with serving cart 50, or additional configurations for heating food using some other system that does not include serving cart 50. For example, in other embodiments, additional features may be included as part of serving cart 50 such as lighting positioned above surface 52. The lighting may be used to simply provide additional light or may be used to provide light and heat. In the latter situation, the food in containers 70 is heated both by the overhead heat lamps and surface 52. In other embodiments, a fixed buffet table may be used instead of serving cart 50. In this embodiment, power source 58 may be placed underneath the table (desirably in some type of enclosure to make it more aesthetically pleasing) and used to provide power to heat surface 52. In additional embodiments, surface 52 may not be heated. Rather, heating elements 82 may be placed directly on containers 70 which are placed on surface 52.

Referring to FIG. 5, a perspective view of another system for heating food using a battery and/or fuel cell is shown. In particular, a serving station 84 is shown which comprises a base 90 and a lighting apparatus 88. Lighting apparatus 88 is fixed to base 90 using support members 92. Base 90 comprises surface 52, which is configured to support containers 70. Surface 52 may be configured in any of the numerous ways described in connection with serving cart 50 (e.g., surface 52 is heated using heating element 82, etc.). In general, power source 58 is configured to be used to heat surface 52 and, thus, heat the food in containers 70. Serving station 84 shown in FIG. 5 is portable. Also, in one embodiment, serving station 84 may be partially disassembled to make it easier to transport (e.g., lighting apparatus 88 is removable from base 90).

Lighting apparatus 88 comprises lights (not shown) and control panel 60. Control panel 60, in this embodiment, is configured to control the temperature of surface 52 as well as the lights. Accordingly, control panel 60 may include all of the options and features as described previously in connection with serving cart 50. The lights are typically heat lamps, which are configured to assist in heating the food in containers 70. Also, lighting apparatus 88 is coupled to breath protectors 86, which are generally configured to prevent matter from a users eyes, mouth, nose, etc. from contaminating the food.

The particular details, design, and features of serving station 84 may be varied in a number of ways. For example, in one embodiment, serving station 84 may be configured without lighting apparatus 88. Rather, serving station 84 may be configured to include only base 90. Also, serving station 84 may not be portable. Instead, it may be fixedly mounted to a table or serving island (e.g., a serving island in a buffet restaurant, etc.). Other variations that would be recognized by those of ordinary skill may also be made to serving station 84 shown in FIG. 5.

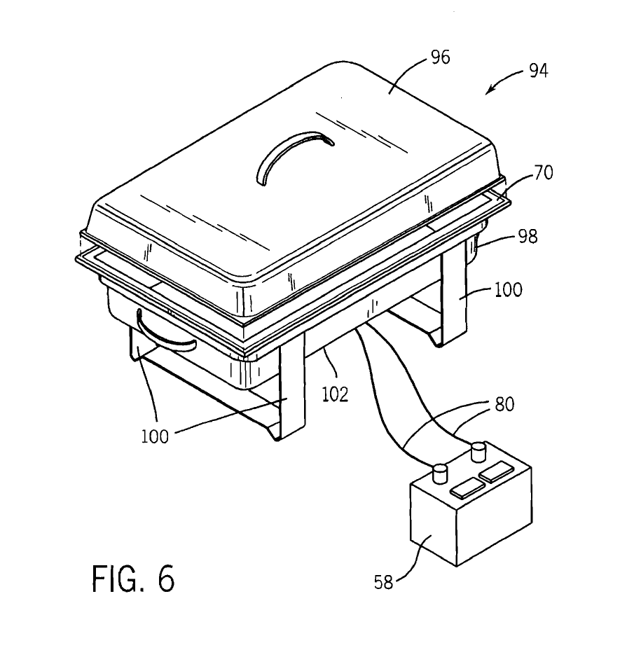

Referring to FIG. 6, another system is shown for heating food using a battery and/or a fuel cell. In this embodiment, a chafing dish 94 is heated using power source 58. Chafing dish 94 comprises cover 96, holder 98, container or serving dish 70, and support members 100. Chafing dish 94 is typically used to heat a single food item. A portable buffet may be created using one or more chafing dishes 94 to serve food at locations where it would otherwise be difficult to keep the food warm (e.g., outdoor weddings, conference rooms, etc.).

Chafing dish 94 is configured to hold food in container 70. The food is heated using one or more heating elements 82 which are positioned on a bottom side 102 of holder 98. Power source 58 provides power to heating elements 82, which heat the food. In one embodiment, power source 58 is a battery and/or a fuel cell. In another embodiment, power source 58 provides direct current power to heating elements 82. Typically, container 70 may be easily removed from holder 98. Thus, a full container 70 may be easily swapped for an empty container 70. Cover 96 is used to cover the food in container 70 until it is ready to be served. Thus, cover 96 prevents some heat loss as well as protecting the food from insects and the like. In one embodiment, the space between container 70 and holder 98 comprises water, which is heated to provide more uniform heating of the food in container 70.

Other embodiments beyond the particular details of chafing dish 94 may also be used to heat food using a battery and/or a fuel cell. For example, in one embodiment, chafing dish 94 may be substantially round. In another embodiment, cover 96 of chafing dish 94 may be rotatably mounted to holder 98. For example cover 96 and holder 98 may be shaped similar to a cylinder split in half longitudinally. When cover 96 is positioned over holder 98, chafing dish 94 is shaped similarly to a cylinder. Cover 96 may then be rotated about an axis that extends longitudinally in the middle of the cylinder shaped chafing dish 94. This provides for easy storage of cover 96 when not in use.

The construction and arrangement of the elements described herein are illustrative only. Although only a few embodiments have been described in detail in this disclosure, those of ordinary skill who review this disclosure will readily appreciate that many modifications are possible without materially departing from the novel teachings and advantages of the subject matter recited in the claims. Accordingly, all such modifications are intended to be included within the scope of the methods and systems described herein. The order or sequence of any process or method steps may be varied or re-sequenced according to alternative embodiments. Other substitutions, modifications, changes and omissions may be made in the design, operating conditions and arrangement of the embodiments without departing from the spirit and scope of the methods and systems described herein.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., consensus definitions from widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

As used herein, spatial or directional terms, such as “left,” “right,” “front,” “back,” and the like, relate to the subject matter as it is shown in the drawing FIGS. However, it is to be understood that the subject matter described herein may assume various alternative orientations and, accordingly, such terms are not to be considered as limiting. Furthermore, as used herein (i.e., in the claims and the specification), articles such as “the,” “a,” and “an” can connote the singular or plural. Also, as used herein, the word “or” when used without a preceding “either” (or other similar language indicating that “or” is unequivocally meant to be exclusive—e.g., only one of x or y, etc.) shall be interpreted to be inclusive (e.g., “x or y” means one or both x or y). Likewise, as used herein, the term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification are understood as modified in all instances by the term “about.” At the very least, and not as an attempt to limit the application of the doctrine of equivalents to the claims, each numerical parameter recited in the specification or claims which is modified by the term “about” should at least be construed in light of the number of recited significant digits and by applying ordinary rounding techniques. Moreover, all ranges disclosed herein are to be understood to encompass any and all subranges subsumed therein. For example, a stated range of 1 to 10 should be considered to include any and all subranges between and inclusive of the minimum value of 1 and the maximum value of 10; that is, all subranges beginning with a minimum value of 1 or more and ending with a maximum value of 10 or less (e.g., 5.5 to 10).

An electronic control system, which may include a microprocessor, may be used to control heating of the surface 52. A control panel 60 provides a user interface with the electronic control system. Control panel 60 comprises a knob 62, display 64, and on/off switch 66. Knob 62 is used to adjust the temperature of surface 52. Display 64 may be used to indicate the temperature of surface 52. Control panel 60 may comprise membrane buttons to input the temperature settings, etc. The electronic control system may be used to control the temperature of surface 52 using a feedback control loop. For example, a thermostat may be used to control the temperature of the surface 52 at a set temperature. In those situations where the surface 52 is included as part of the serving cart 50 or other suitable portable unit, the control panel 60 may be positioned on the serving cart 50. In other embodiments, where the surface 52 is built-in, the control panel 60 may be positioned remotely from the surface 52 or immediately adjacent to the surface 52.

What is claimed is:

1. A system for heating food comprising:
a surface that includes a mineral and organic resin, the surface being configured to receive and heat food; and
a heating element which is in thermal communication with the surface.

2. The system of claim 1 wherein the surface includes at least about 2 wt. % organic resin.

3. The system of claim 1 wherein the surface includes polyester resin.

4. The system of claim 1 wherein the surface includes quartz.

5. The system of claim 1 wherein the surface includes engineered stone.

6. The system of claim 1 comprising at least one of a battery or a fuel cell which is configured to provide power to the at least one heating element.

7. The system of claim 1 comprising a control panel which is configured to receive input from a user to select a temperature setting for the surface.

8. A system for heating food comprising:
a surface that includes a mineral other than quartz and organic resin, the surface being configured to receive and heat food; and
at least one heating element which is in thermal communication with the surface.

9. The system of claim 8 wherein the surface includes at least about 2 wt. % organic resin.

10. The system of claim 8 wherein the surface includes polyester based resin, polyvinyl based resin, and/or acrylate based resin.

11. The system of claim 8 wherein the surface includes a low profile additive.

12. The system of claim 8 comprising at least one of a battery or a fuel cell which provides power to the heating element.

13. The system of claim 8 comprising a thermostat which controls the temperature of the surface.

14. The system of claim 8 wherein the surface is compression molded.

15. A system for heating food comprising:
a surface that includes a fibrous material and organic resin, the surface being configured to receive and heat food; and
at least one heating element which is in thermal communication with the surface.

16. The system of claim 15 wherein the surface includes a mineral.

17. The system of claim 15 wherein the surface includes at least about 2 wt. % organic resin.

18. The system of claim 15 wherein the surface includes polyester based resin, polyvinyl based resin, and/or acrylate based resin.

19. The system of claim 15 wherein the surface includes glass fiber.

20. The system of claim 15 comprising a thermostat which controls the temperature of the surface.

21. The system of claim 15 wherein the surface is compression molded.

22. A system for heating food comprising:
a compression molded surface that includes organic resin, the compression molded surface being configured to receive and heat food; and
at least one heating element which is in thermal communication with the compression molded surface.

23. The system of claim 22 wherein the compression molded surface includes a mineral.

24. The system of claim 22 wherein the compression molded surface includes at least about 2 wt. % organic resin.

25. The system of claim 22 wherein the compression molded surface includes polyester based resin, polyvinyl based resin, and/or acrylate based resin.

26. The system of claim 22 comprising a thermostat which controls the temperature of the compression molded surface.

27. A system for heating food comprising:
a surface that includes an inorganic filler and at least one of polyester based resin, polyvinyl based resin, or acrylate based resin, the surface being configured to receive and heat food; and
at least one heating element which is in thermal communication with the surface.

28. The system of claim 27 wherein the surface includes a mineral.

29. The system of claim 27 wherein the surface includes a fibrous material.

30. The system of claim 27 wherein the surface includes at least about 2 wt. % polyester based resin.

31. The system of claim 27 comprising a thermostat which controls the temperature of the surface.

32. A system for heating food comprising:
a surface that includes a mineral, glass fiber, and at least one of polyester based resin, polyvinyl based resin, or acrylate based resin, the surface being configured to receive and heat food; and
at least one heating element which is in thermal communication with the surface.

33. The system of claim 32 wherein the surface includes at least about 2 wt. % polyester resin.

34. The system of claim 32 comprising a thermostat which controls the temperature of the surface.

35. The system of claim 32 wherein the surface includes acrylic modified polyvinyl acetate.

36. A system for heating food comprising:
a counter including a concrete surface configured to receive and heat food; and
a heating element which is in thermal communication with the surface.

37. The system of claim 36 wherein the counter is portable.

38. The system of claim 36 wherein the concrete surface comprises aesthetic filler material.

39. The system of claim 38 wherein the concrete surface includes embedded glass.

40. The system of claim 36 wherein the concrete surface is polished.

41. The system of claim 36 wherein the concrete surface is honed.

42. The system of claim 36 wherein the heating element is positioned inside the concrete surface.
